(19) United States
(12) Patent Application Publication
(10) Pub. No.: US 2024/0328531 A1
(43) Pub. Date: Oct. 3, 2024

(54) Dual Flush Flushometer System

(71) Applicant: Sloan Valve Cpmpany, Franklin Park, IL (US)

(72) Inventor: Hemant Sharma, Gurgaon (IN)

(21) Appl. No.: 18/622,266

(22) Filed: Mar. 29, 2024

(30) Foreign Application Priority Data
Mar. 31, 2023 (IN) 202311024483

(51) Int. Cl. F16K 31/383; E03D 3/04; E03D 5/02

(52) U.S. Cl. CPC F16K 31/383; E03D 3/04; E03D 5/028

(57) ABSTRACT

A flushometer system includes a valve body having an inlet, an outlet, and an actuation opening, a main valve seat assembly disposed in the valve body, a piston assembly slidably disposed within the valve body and configured for sealing the main valve seat assembly and moving to permit liquid to flow through the main valve seat assembly, and an actuation module engaged with the valve body. A relief chamber is defined between the actuation module and the piston assembly, and the actuation module is configured to vent the relief chamber upon actuation. The actuation module includes first and second plungers. The first plunger and the second plungers are moveable to vent the relief chamber, where the piston assembly moves to permit water to flow through the main valve seat assembly. Movement of the first plunger allows a larger flush volume to pass through the main valve seat assembly than movement of the second plunger.

### CROSS-REFERENCE TO RELATED APPLICATION

This application claims priority to and the benefit of Indian patent application Ser. No. 202311024483, filed Mar. 31, 2023, which prior application is incorporated by reference herein in its entirety.

### FIELD OF THE INVENTION

This disclosure relates to systems for flushometers, and more specifically to flushometers having dual flush functionality, which may be disposed behind or in a wall.

### BACKGROUND

Flushometers are a ubiquitous presence in most commercial restrooms, as well as in many homes. Many known flushometers possess dual-flush functionality, where the flushometer is capable of two different flush cycles providing two different flush volumes. In-wall flushometers are also known, including flushometers using a three-port design. However, current dual-flush flushometers do not provide satisfactory performance in many applications, including in particular in-wall installations, three-port configurations, and low flush volume configurations.

The present disclosure is provided to address this need and other needs in existing dual-flush flushometers. A full discussion of the features and advantages of the present invention is deferred to the following detailed description, which proceeds with reference to the accompanying drawings.

### BRIEF SUMMARY

Aspects of the disclosure relate to a flushometer system that includes a valve body having an inlet, an outlet, and an actuation opening, a main valve seat assembly disposed in the valve body between the inlet and the outlet, a piston assembly slidably disposed within the valve body and configured for sealing the main valve seat assembly and moving to permit liquid to flow through the main valve seat assembly, and an actuation module engaged with the valve body. A relief chamber is defined between the actuation module and the piston assembly, and the actuation module is configured to vent the relief chamber upon actuation. The actuation module includes a first plunger and a second plunger. The first plunger is moveable to vent the relief chamber such that the piston assembly is configured to move a first distance from the main valve seat assembly to permit a first flush volume to flow through the main valve seat assembly. The second plunger is moveable to vent the relief chamber such that the piston assembly is configured to move a second distance from the main valve seat assembly that is smaller than the first distance to permit a second flush volume to flow through the main valve seat assembly. The second flush volume is smaller than the first flush volume.

According to one aspect, the flushometer system further includes a sleeve adjustably engageable with the valve body. The sleeve is movable relative to the valve body to be engaged and disengaged from the main valve seat assembly. The piston assembly is slidably disposed within the sleeve, and the relief chamber is defined within the sleeve. In one configuration, the actuation module is removably engageable with the sleeve.

According to another aspect, the inlet and outlet have a vertical axis running therethrough and the actuation opening is perpendicular to the vertical axis and defines a horizontal axis.

According to a further aspect, the first plunger has a central passage extending therethrough, and the second plunger is slidably disposed within the central passage of the first plunger. In one configuration, the first plunger is moveable independently of the second plunger. In another configuration, movement of the second plunger is configured to cause movement of the first plunger to vent the relief chamber.

According to yet another aspect, the second plunger has a distal end extending into the relief chamber, and the distal end of the second plunger is configured to engage the piston assembly to obstruct movement of the piston assembly when the second plunger is moved to vent the relief chamber.

According to a still further aspect, the flushometer system includes a first biasing member configured to bias the first plunger away from the piston assembly and a second biasing member configured to bias the second plunger away from the piston assembly.

According to an additional aspect, the piston assembly further includes a piston configured to move away from the main valve seat assembly when the relief chamber is vented and a flow control extending from the piston assembly into the main valve seat assembly.

Additional aspects of the disclosure relate to a face plate assembly configured for manual actuation of a flushometer mounted within or behind a wall surface, where the manual flushometer has a first plunger and a second plunger. The face plate assembly includes a face plate configured for mounting on the wall surface, a mounting ring mounted behind the face plate and configured to be engaged with the flushometer, and an actuator assembly including a first actuator and a second actuator pivotably mounted on the mounting ring and positioned within an opening in the face plate. The first actuator has a first actuation member configured to operably engage the first plunger move the first plunger when the first actuator is pivoted toward the flushometer, and the second actuator has a second actuation member configured to operably engage the second plunger move the second plunger when the second actuator is pivoted toward the flushometer.

According to one aspect, the first actuator overlies a portion of the second actuator.

According to another aspect, the first actuator and the second actuator are pivotably coupled to a rod defining a single pivot axis for the first actuator and the second actuator.

According to a further aspect, the first actuator and the second actuator are further pivotable away from the flushometer to an access position configured to permit access to the flushometer. The first actuator has an arm engaging the second actuator, such that movement of the first actuator to the access position is configured to move the second actuator to the access position.

According to yet another aspect, the first actuator has an additional first actuation member, wherein the second actuator has a slot, and the additional first actuation member is received through the slot and configured to operably engage the first plunger through the slot.

Other features and advantages of the disclosure will be apparent from the following description taken in conjunction with the attached drawings.

### BRIEF DESCRIPTION OF THE DRAWINGS

To allow for a more full understanding of the present disclosure, it will now be described by way of example, with reference to the accompanying drawings in which:

FIG. 1 is a perspective view of one embodiment of a flushometer system and a face plate assembly according to aspects of the disclosure;

FIG. 2 is a perspective view of the flushometer system of FIG. 1;

FIG. 3 is a cross-section view taken along lines 3-3 of FIG. 1;

FIG. 4 is a cross-section view taken along lines 4-4 of FIG. 2;

FIG. 5 is a cross-section view of the flushometer system of FIG. 3, shown in an equilibrium state;

FIG. 6 is a cross-section view of the flushometer system of FIG. 5, shown in a first action of a full flush cycle;

FIG. 7 is a cross-section view of the flushometer system of FIG. 5, shown in a second action of a full flush cycle;

FIG. 8 is a cross-section view of the flushometer system of FIG. 5, shown in a third action of a full flush cycle;

FIG. 9 is a cross-section view of the flushometer system of FIG. 5, shown in a fourth action of a full flush cycle;

FIG. 10 is a cross-section view of the flushometer system of FIG. 5, shown in a first action of a half flush cycle;

FIG. 11 is a cross-section view of the flushometer system of FIG. 5, shown in a second action of a half flush cycle;

FIG. 12 is a cross-section view of the flushometer system of FIG. 5, shown in a third action of a half flush cycle;

FIG. 13 is a perspective view of a first plunger and a second plunger of the flushometer system of FIG. 5;

FIG. 14 is a perspective view of another embodiment of a first plunger usable with the flushometer system of FIG. 5;

FIG. 15 is a perspective view of another embodiment of a second plunger usable with the flushometer system of FIG. 5;

FIG. 16 is a perspective view of the manual actuator assembly of FIG. 1;

FIG. 17 is a rear perspective view of the manual actuator assembly of FIG. 16;

FIG. 18 is a rear perspective view of the manual actuator assembly of FIG. 16, with components removed to show internal detail;

FIG. 19 is a rear perspective view of a first actuator and a second actuator of the manual actuator assembly of FIG. 16;

FIG. 20 is a rear perspective view of the first actuator of FIG. 19;

FIG. 21 is a rear perspective view of the second actuator of FIG. 19;

FIG. 22 is a front perspective view of the second actuator of FIG. 19;

FIG. 23 is a bottom front perspective view of the first and second actuators of FIG. 19 in a service position;

FIG. 24 is a front perspective view of the flushometer system and the face plate assembly of FIG. 1, with the first and second actuators in the service position; and

FIG. 25 is a side perspective view of the flushometer system and the face plate assembly of FIG. 1 installed on a wall.

### DETAILED DESCRIPTION

While this invention is susceptible of embodiments in many different forms, there are shown in the drawings and will herein be described in detail example embodiments of the invention with the understanding that the present disclosure is to be considered as an exemplification of the principles of the invention and is not intended to limit the broad aspect of the invention to the embodiments illustrated. In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention.

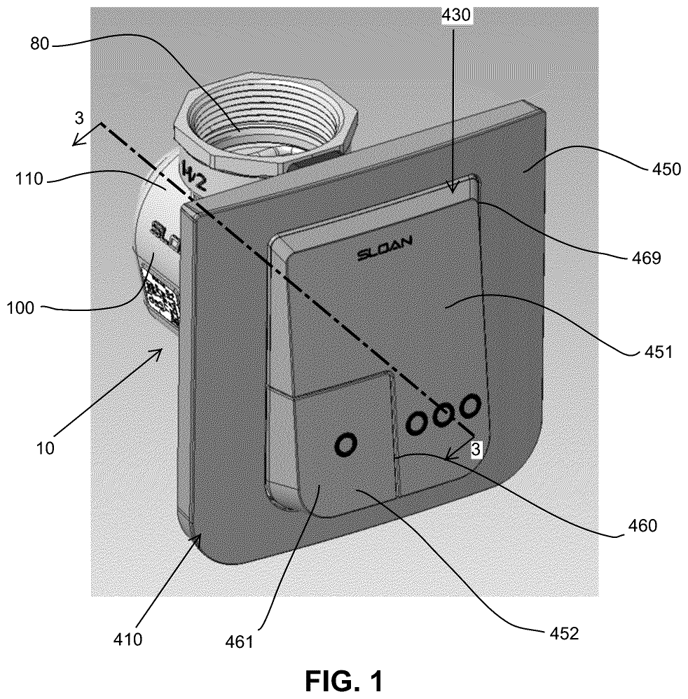

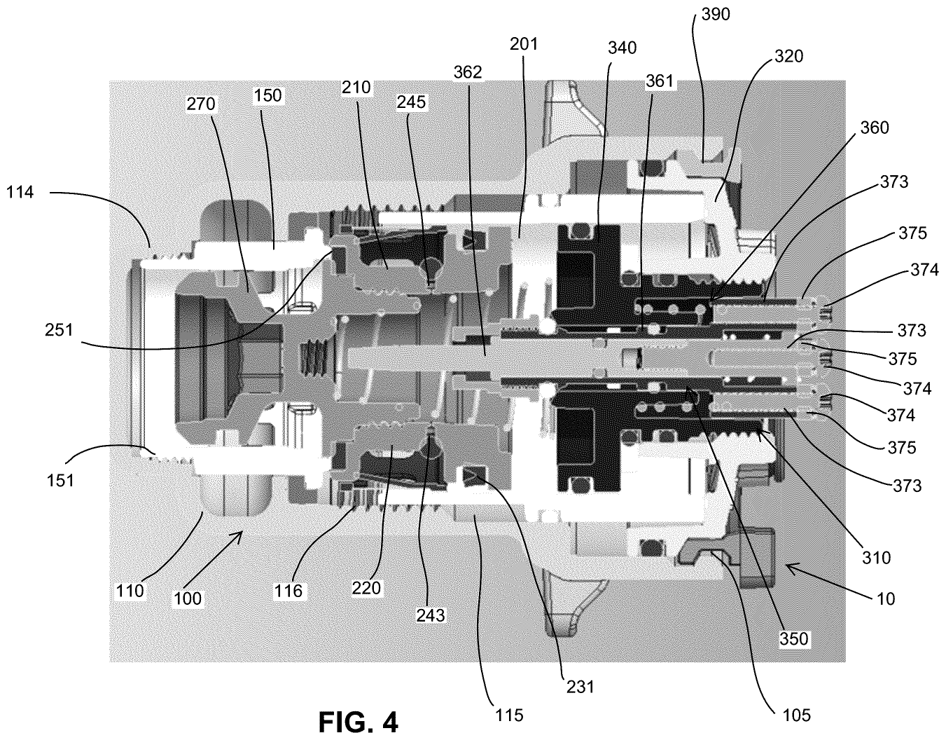

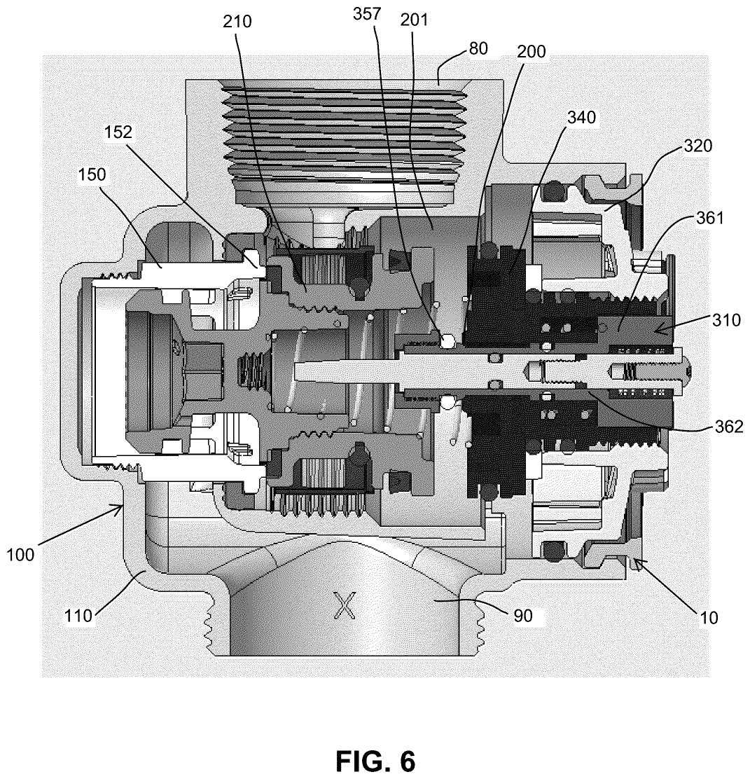

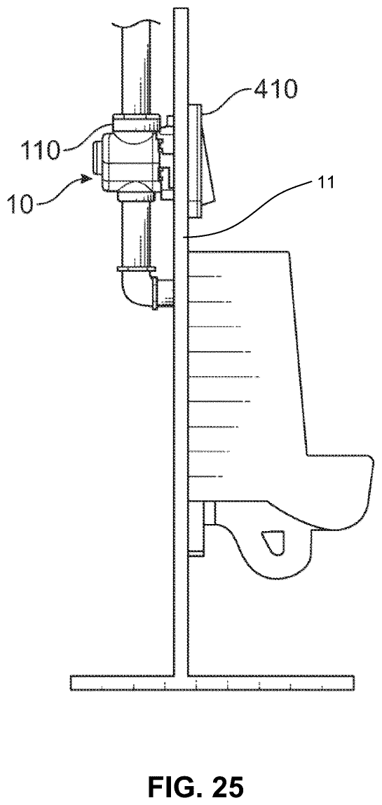

FIGS. 1-5 generally illustrate the structure of one embodiment of a flushometer system 10 that is capable of full flush and half flush functionality. As used herein, the terms “full flush” and “half flush” are used to refer to larger and smaller flush volumes, respectively, and these terms should not be interpreted to require that the “half flush” volume is any particular proportion (e.g., 50%) of the “full flush” volume. FIGS. 6-12 illustrate sequential actions in the full flush and half flush cycles of the flushometer system 10, and FIG. 25 illustrates installation of the flushometer system 10 behind a wall surface 11. As seen in FIGS. 1-5, the flushometer system 10 includes a flushometer 100 with a valve body 110 with an inlet 80 and an outlet 90. The inlet 80 may be positioned at a top of the valve body 110 and the outlet 90 positioned at the bottom. An actuation opening 105 may be positioned substantially perpendicular to an axis running through the inlet 80 and outlet 90. It should be appreciated the positioning of the inlet 80, outlet 90, and actuation opening 105 relative to space (i.e., up/down/etc.) can be changed and the described relative orientations maintained as described. In the embodiment illustrated in FIG. 1-5, the inlet 80 and the outlet 90 are parallel, essentially providing fluid at a top of the valve body 110 and evacuating fluid at the bottom. The actuation opening 105 is positioned perpendicular to the inlet 80 and outlet 90. However, in alternative embodiments, the inlet 80 may be positioned on alternative “faces” of the valve, for example positioned for a side-entry, perpendicular to both the actuation opening 105 and the outlet 90.

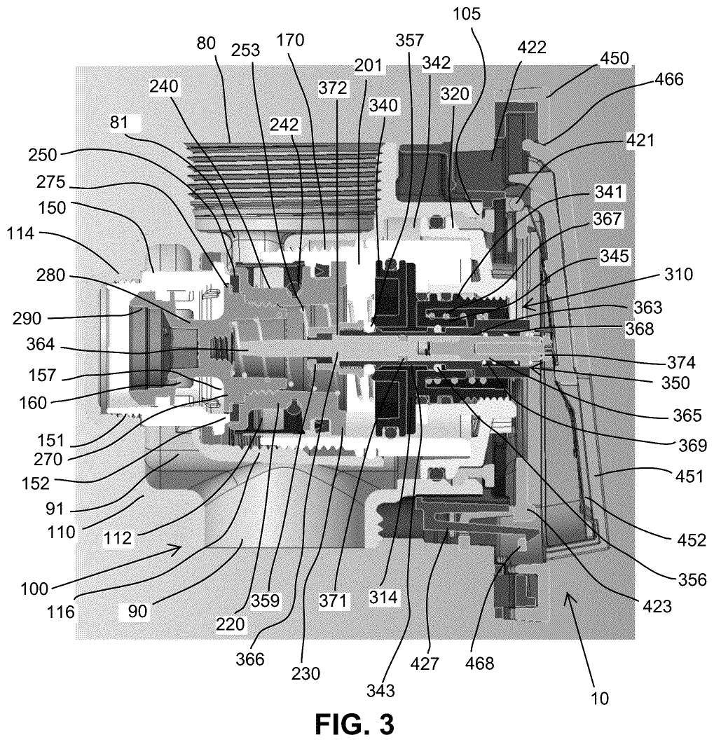

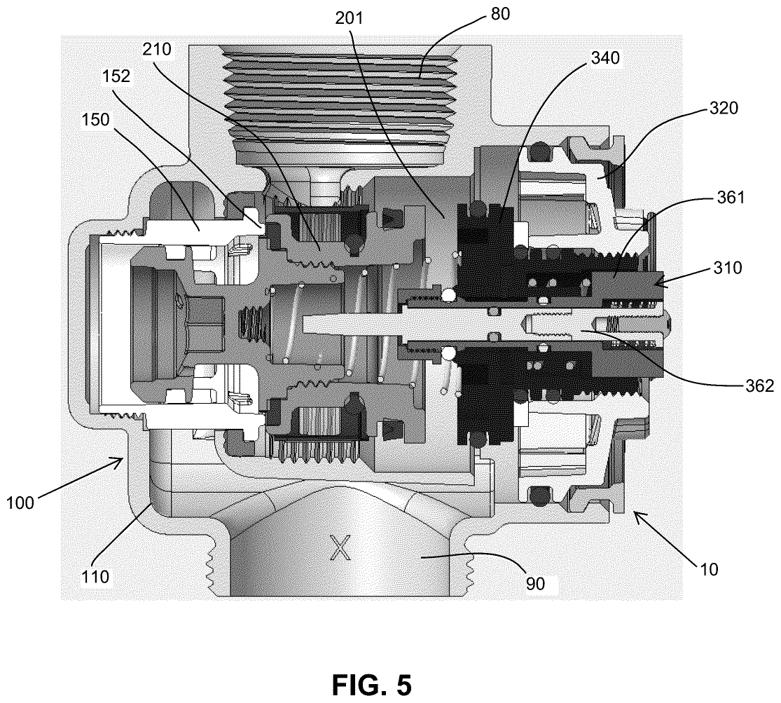

Disposed between the inlet 80 and the outlet 90, as well as adjacent the actuation opening 105, is a valve chamber 112 defined within a sleeve 170, in which a piston assembly 210 and a main valve seat 152 are positioned and which is defined by the space between the piston assembly 210, the inlet 80, and the outlet 90, and through which water flows during a flush. The valve chamber 112 is open to the inlet 80 through the inlet aperture 81, which may be sealed by the sleeve 170 acting as a control stop through engagement of the main valve seat assembly 150 by the sleeve 170 as described below. The valve chamber 112 is open to the outlet 90 through the valve chamber outlet 91 (best seen in FIGS. 3-5), controlled by the main valve seat assembly 150 as described below. The valve chamber 112 is open to the actuation opening 105, sealed by the actuation module 310 and piston assembly 210 as described below. Thus, water flows through the valve chamber 112 controlled or sealed at each opening by structures as indicated below. The sleeve 170 is not shown in FIGS. 5-12, to aid in visibility of other components.

In one embodiment, best shown in FIGS. 3 and 5, the inlet 80 includes an inlet aperture 81. The inlet aperture 81 may have a smaller area than the inlet 80. Further, the inlet aperture 81 may have a selected shape, such as a rectangle with curved corners. The inlet aperture 81 serves to restrict the flow of water into the valve chamber 112. In one embodiment, the inlet aperture 81 allows water to flow to the piston assembly 210 with a minimum number of turns in its flow path from the inlet 80. In addition, the inlet aperture 81 may interact with the sleeve 170 as described below.

The valve chamber 112 includes a valve seat receptacle 114, as shown in FIGS. 3-5. The valve seat receptacle 114 may comprise a threaded portion of the valve body 110 within the valve chamber 112 or may include a physical structure to allow for a main valve seat assembly 150 to be retained, such as by snap-fit, twist-and-lock, or the like. In one embodiment, the valve seat receptacle 114 is adjacent the valve chamber outlet 91 (best illustrated in FIGS. 3 and 5). In one embodiment, the valve seat receptacle 114 and main valve seat assembly 150 are sized to position a main valve seat 152 of the main valve seat assembly 150 adjacent the inlet aperture 81, such as best seen in FIGS. 3 and 5.

The main valve seat assembly 150 includes a retention mechanism 151, a main valve seat 152, a main valve inlet 157 and one or more main valve outlets 160. In one embodiment, a main valve seat assembly control stop seal (not shown) may be provided adjacent to the retention mechanism 151, to engage the sleeve 170 to function as a control stop, sealing water from entering the valve chamber 112. In the illustrated embodiment, the main valve seat assembly 150 is substantially circular in cross-section, forming a generally cylindrical shape with an outer wall and both faces of the cylinder being openings. The main valve seat 152 circumscribes the main valve inlet 157, which opens into the interior of the main valve seat assembly 150, which is essentially defined by a housing or structure about the periphery. The valve seat receptacle 114 of the embodiment of FIGS. 1-5 includes a threaded portion which extends into a portion of the valve chamber 112 opposite of the actuation opening 105. Thus, as seen in FIGS. 3-5, the main valve seat assembly 150 may be connected to the valve body 110 by threading the retention mechanism 151 into the valve seat receptacle 114 of the valve body 110. The one or more main valve outlets 160 are voids, windows, openings, or the like, in the housing of the main valve seat assembly 150. The one or more main valve outlets 160 provide for communication from within the main valve seat assembly 150 and the outlet 90. Thus, water can flow through the main valve inlet 157 through the interior of the main valve seat assembly 150 and through the one or more main valve outlets 160.

When the main valve seat assembly 150 is positioned in the valve body 110, any fluid that would flow through the flushometer 100, must flow through the inlet aperture 81, over the main valve seat 152, through the main valve inlet 157 and then out the one or more main valve outlets 160. The one or more main valve outlets 160 open to the outlet 90 through the valve chamber outlet 91.

In the embodiment of FIGS. 1-5, a sleeve receptacle 116 of the valve body 110 is configured to receive the sleeve 170. The sleeve 170 may be a cylindrical (or similar) structure defining a hollow interior and open at both faces of the cylindrical shape. The sleeve receptacle 116 may comprise a threaded portion of the valve body 110 within the valve chamber 112 or may include a physical structure to allow for the sleeve 170 to be retained, such as by snap-fit, twist-and-lock, or the like. The sleeve 170 interacts with the piston assembly 210 and the actuation module 310 to define a relief chamber 201. In the embodiment of FIGS. 1-5, the piston assembly 210 and the sleeve 170 are engageable with an actuation module 310, with the actuation assembly and sleeve 170 defining the relief chamber 201 where the piston 220 is disposed. The actuation module 310 is actuated by an actuation mechanism 350, as described in greater detail below.

In addition, the sleeve 170 also provides a shut-off mechanism or “control stop” valve. Thus, the control stop is integrated with the valve itself rather than positioned as a separate structure on the water line as is typical. As best seen in FIGS. 3-5, the sleeve 170 has a sleeve valve seat end which is positioned nearest to the main valve seat 152 and the inlet aperture 81 and an opposite bonnet end that engages with the bonnet 320 of the actuation module 310 as described below. The sleeve 170 may be adjustable relative to the control stop seal (not shown) of the main valve seat assembly 150 and/or the inlet aperture 81. The sleeve 170 may, thus, be repositioned to adjust the relative position of the sleeve 170 and the inlet aperture 81 and main valve seat 152. The sleeve 170 can extend towards the main valve seat 152, covering a portion or the entire inlet aperture 81. When the sleeve 170 is advanced towards the main valve seat 152 to contact the main valve seat 152, the main valve inlet 157 is effectively sealed off from the inlet aperture 81, thus closing the flushometer 100 from supply water.

In one embodiment, the sleeve 170, in conjunction with the control stop seal, is an adjustable throttling mechanism. That is, the space between the sleeve 170 and the control stop seal can be adjusted as desired to restrict flow, allowing for adjustment to the GPM of water passing through the inlet 80 and through the main valve outlets 160.

In the embodiment of FIGS. 1-5, a piston assembly 210 is engaged with the main valve seat assembly 150 and the sleeve 170. It is understood that the piston assembly 210 may be replaced by a diaphragm assembly in another embodiment. The piston assembly 210 is inserted within the valve body 110 through the actuation opening 105. The piston assembly 210 is disposable within the interior of the sleeve 170 and engageable with the main valve seat assembly 150. One embodiment of the piston assembly 210 includes at least a piston 220 and a flow control 270, as shown in FIGS. 3-5.

As seen in FIGS. 3-5, the piston 220 of the piston assembly 210, is disposed within the sleeve 170. The piston 220 has a hollow body with a largest diameter at a top lip seal portion 230 (activation side), a relief portion 240 having a reduced diameter and positioned in the middle of the piston assembly 210, and a main valve seal portion 250 which is engageable with the main valve seat assembly 150 to close the flushometer 100. In the embodiment of FIGS. 1-5, the flow control 270 is engaged with the main valve seal portion 250 and forms the end of the piston assembly 210.

The top lip seal portion 230 of the piston 220 provides a lip seal 231 between the piston 220 and the sleeve 170. This lip seal 231 separates the relief chamber 201 from the valve chamber 112. In this configuration, the relief chamber 201 is defined by the interior of the piston 220 and between the piston 220 and the actuation module 310. Additionally, in this configuration, the valve chamber 112 is defined within the sleeve 170 and between the sleeve 170 and the piston 220, and the valve chamber 112 extends through to the main valve seat assembly 150 and is in communication with the inlet 80 and, when the valve is open, the outlet 90. The lip seal 231 also serves to maintain the position of the piston assembly 210 relative to the sleeve 170.

The relief portion 240 of the piston 220 includes one or more by-pass openings 245 (see FIG. 3) that allow fluid to pass from the environment outside of the piston 220 (within the valve chamber 112) to within the piston 220 and therethrough to the relief chamber 201. The by-pass openings (not shown) may utilize a filter 242, which may be positioned in a corresponding groove 243, such as a circumferential groove 243. The by-pass openings may be a group of slots or holes within the groove 243. The filter 242 is positioned within the groove 243 and functions to prevent the clogging of the by-pass openings, such as by debris in water from the inlet 80. Preferably there are at least two by-pass openings equally spaced about the relief portion 240.

The main valve seal portion 250 of the piston 220 includes a seal surface 251 for engaging and sealing the valve against the main valve seat 152. The seal surface 251 seats upon the main valve seat 152 when the flushometer 100 is closed. A biasing member 253 engages the piston assembly 210 and a sleeve cap 340 of the actuation module 310 to bias the piston assembly 210 toward the closed position, i.e., where the seal surface 251 of the main valve seal portion 250 seals against the main valve seat 152. The flow control 270 attaches to the piston 220, such as at the main valve seal portion 250.

The flow control 270 of the piston assembly 210 is configured to control and define the flush profile. In the embodiment of FIGS. 1-5, the flow control 270 includes a “dumbbell” shape, with a snubber portion 275, a flush profile portion 280 extending from the snubber portion 275, and a plug portion 290 at the end of the flush profile portion 280. The flush profile portion 280 is smaller in width or circumference than the snubber portion 275 and the plug portion 290. The flow control 270 may be profiled, such as with rounded edges at the downstream portion to provide for water flow efficiency.

The snubber portion 275 is sized so as to have a smaller outer diameter than the main valve seal portion 250 and smaller than the inner diameter of the main valve seat 152. Thus, the snubber portion 275 is able to be disposed within the main valve seat assembly 150, such as when the main valve seal portion 250 is engaged with the main valve seat 152. The height of the snubber portion 275, that is the distance it extends from the main valve seal portion 250 before transitioning to the flush profile portion 280, may be selected to control the behavior of the flushometer 100 at closing. For example, the presence of the snubber portion 275 at the end of a flush cycle reduces the volume of water initially passed through the flushometer 100 and also slows the seating of the main valve seal 251 on the main valve seat 152 as the snubber portion 275 enters the main valve seat assembly 150. This lessens the impact of the flush cycle on the system by more gradually presenting the water flow through the valve rather than immediately moving to a maximum flow rate. Further, the snubber portion 275 may be provided with hydraulic features (not shown) about at least a portion of its periphery, such as refill flow grooves. Such hydraulic features may be used to control the performance just prior to and at the moment of valve closing.

The outer diameter of the plug portion 290 in the embodiment of FIGS. 3-5 is smaller than the outer diameter of the snubber portion 275, so as to avoid the valve running at “full open” in the event the valve fails to close. Thus, if the flow control 270 becomes detached, the device will “fail” with the snubber engaging the main valve seat 152. This will result in substantially lower volume of water per minute passing through the valve than if the valve failed into a fully open status.

The flush profile portion 280 extends from the snubber portion 275. The outer diameter of the flush profile portion 280 is less than that of the snubber portion 275, for example having less than ¾, ½, or ¼ diameter of the snubber portion 275 and/or the plug portion 290. In one embodiment the difference in outer diameter may be partially or completely transitioned by a taper. The size of the outer diameter of the flush profile portion 280 corresponds with the flow rate of the flush or more specifically the flow rate while the flush profile portion 280 is positioned at the main valve seat and controlling fluid flow. The distance the flush profile portion 280 extends from the snubber portion 275 controls the flush timing, or more specifically the flush timing for the associated portion of the flush profile.

The plug portion 290 extends from the flush profile portion 280. The outer diameter of the flush profile portion 280 is less than that of the plug portion 290. In one embodiment the difference in outer diameter may be partially or completely transitioned by a taper, and the plug portion 290 may include contouring for a desired flush profile. The plug portion 290 imparts a “slow open” or “slow opening” to the flushometer system 10. The plug portion 290 hydraulically dampens the movement of the piston, essentially slowing down the opening of the main valve. In some embodiments, the plug portion 290 provides for a reduced impact on the infrastructure of the system due to the slower open. Further, the slow opening allows the purging of air from within the valve at a lower GPM, thus allowing for a more efficient flush as high GPM is not used to move air. The O.D. of plug portion 290 and I.D. of main valve seat assembly 150 define an annulus allowing water flow through the valve when the plug portion 290 is fully engaged with the main valve seat assembly 150. The flow control 270 may include one or more contours on the snubber portion 275, the flush profile portion 280, and/or the plug portion 290, including at the transitions therebetween.

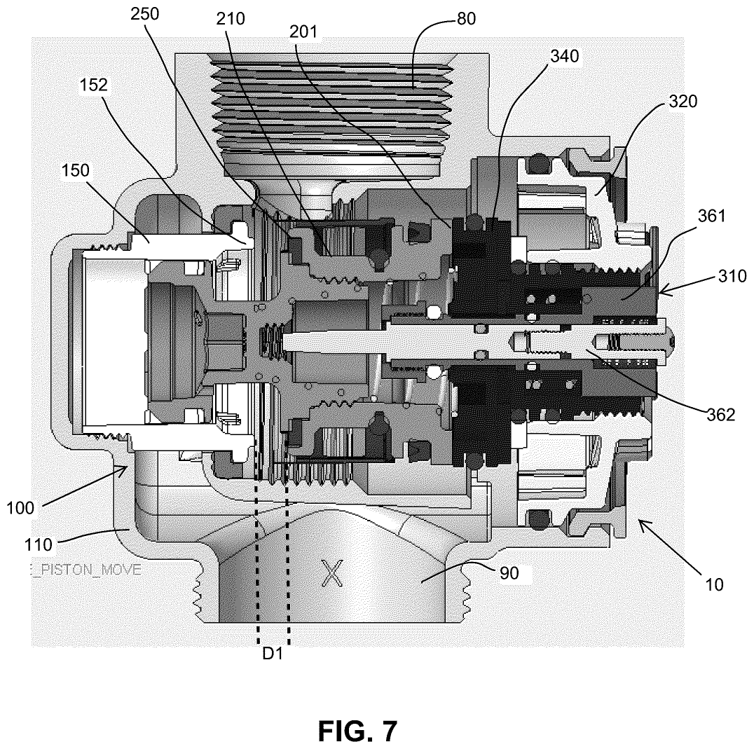

The plug portion 290 may include one or more contours or grooves defining the outer perimeter, which may contribute to defining the flush profile and may also be configured for restricting the maximum flow through the main valve seat assembly 150. When the valve is closed, the plug portion 290 is positioned within the main valve seat assembly 150. As shown in FIGS. 7-8 and 12, during a flush cycle, the plug portion 290 moves relative to the main valve seat 152. When the main valve seal portion 250 disengages from the main valve seat 152, water is able to flow over the main valve seat 152. As the plug portion 290 is still within the main valve seat assembly 150, the water must flow over and around the perimeter of the plug portion 290. As the plug portion 290 is present in the path of the water through the main valve seat assembly 150, the volume flow rate (e.g., GPM) of water able to pass through the main valve seat assembly 150 is reduced depending on the dimensions and contours of the plug portion 290.

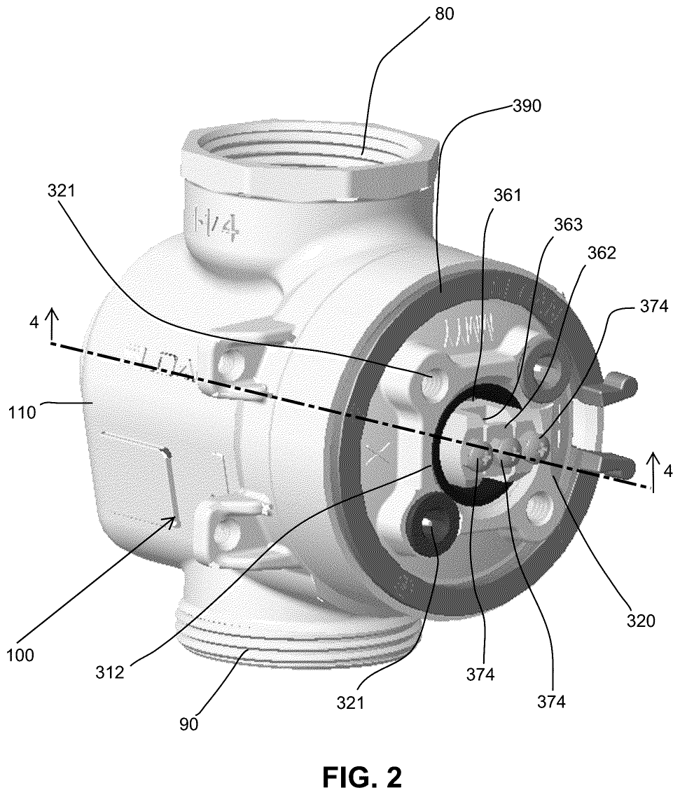

The actuation module 310, as shown in FIGS. 2-5, is located on the opposite end of the piston assembly 210 as the main valve seat assembly 150 is engaged. The valve body 110 has an increased diameter at the actuation opening 105, as compared to the sleeve receptacle 116 portion of the valve chamber 112. The increased diameter of the valve body 110 from the sleeve receptacle 116 to the actuation opening 105 defines a venting chamber 115 about the sleeve 170 and between the sleeve 170 and the valve body 110, which is further defined by the actuation module 310. This venting chamber 115 is in fluid communication with the outlet 90.

In the embodiment of FIGS. 1-5, the proximal end of the sleeve 170 is received within a bonnet 320 of the actuation module 310, which connection may include interlocking or other mating structures, e.g., splines and sprockets, tongue and groove, turn-and-lock, press-fit, or the like. The connection between the actuation module 310 and the sleeve 170 is such that the actuation module 310 is capable of being removed as further described below, and also such that rotation of the actuation module 310 rotates the sleeve 170. For example, rotation of the actuation module may cause the sleeve to interact with the retention mechanism to move the sleeve relative to the main valve seat assembly 150, closing the valve through action of the sleeve as a control stop.

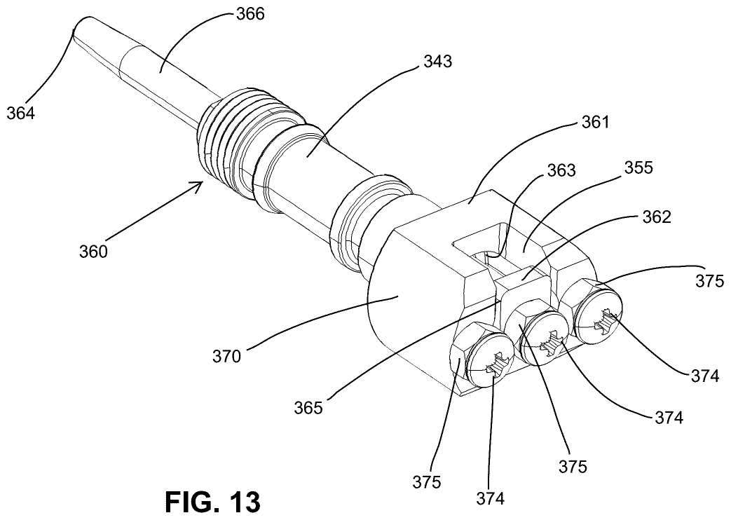

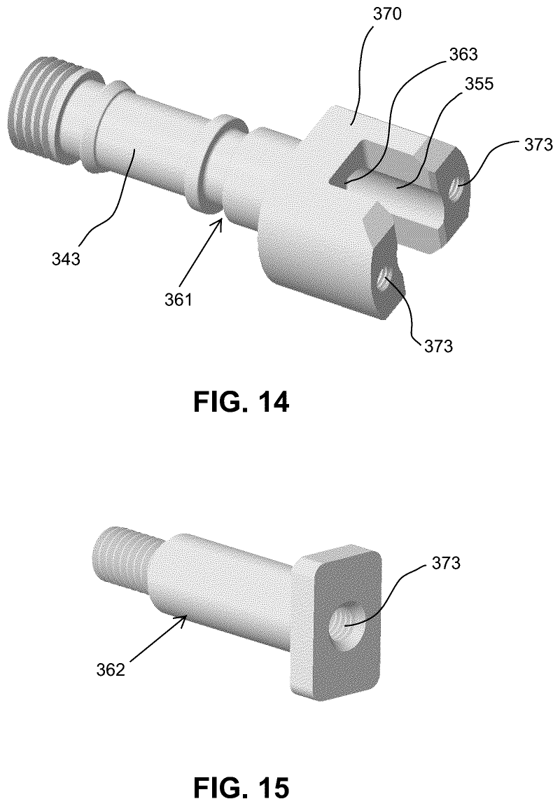

The actuation module 310 as shown in FIGS. 1-5 is a manual actuation module that enables dual flush functionality, permitting operation of the flushometer 100 in a full flush cycle and a half flush cycle. The actuation module 310 in this embodiment includes a bonnet 320 with an actuation module passage 312 and a sleeve cap 340 with a mounting stem 341 extending upward to connect to the bonnet 320 by threading within the center of the bonnet 320. The sleeve cap 340 defines the actuation module passage 312 therethrough, and a plunger assembly 360 extends from a top of the bonnet 320 through the actuation module passage 312. The plunger assembly 360 includes a first plunger or full flush plunger 361 and a second plunger or half flush plunger 362. The first plunger 361 has a central passage 363 extending axially through the entire length of the first plunger 361, and the second plunger 362 extends through the central passage 363 and is positioned within the first plunger 361. The second plunger 362 has a length that is greater than that of the first plunger 361, such that a distal end 364 of the second plunger 362 projects from the central passage 363 of the first plunger 361. The second plunger 362 includes a head piece 365 and an end piece or shaft 366 connected to the end of the head piece 365, with the shaft 366 forming the distal end 364 of the second plunger 362. FIG. 13 shows an example embodiment of the assembled plunger assembly 360. FIG. 14 shows an embodiment of the first plunger 361, and FIG. 15 shows an embodiment of the head piece 365 of the second plunger 362. The head piece 365 in this embodiment has an elongated, rectangular shape at the proximal end, and the head 370 of the first plunger 361 has a slot 355 configured to receive the head piece 365.

The mounting stem 341 of the sleeve cap 340 has an internal wall 345 defining part of the actuation module passage 312, through which the first and second plungers 361, 362 are received. The first and second plungers 361 are both axially and linearly moveable with respect to the bonnet 320 and the sleeve cap 340, between a first or retracted position and a second or extended position. A first biasing member 367, such as a spring, engages the sleeve cap 340 and the first plunger 361 to bias the first plunger 361 toward the retracted position. Additionally, the end of the internal wall 345 is configured to abut a portion of the first plunger 361 to limit a range of movement of the first plunger 361. The first biasing member 367 encircles the internal wall 345 in the embodiment of FIGS. 1-5. A second biasing member 368, such as a spring, engages the first biasing member 367 and the head piece 365 of the second biasing member 368 to bias the second biasing member 368 toward the retracted position. The central passage 363 of the first plunger 361 has an enlarged portion 369 at the proximal end that receives the second biasing member 362 therein. The plunger assembly 360 also includes a cap 359 fixedly connected to the distal end of the first plunger 361, and the distal end 364 of the second plunger 362 extends through and out of the cap 359. The second plunger 362 is moveable with respect to the cap 359 in this embodiment.

The first plunger 361 in the embodiment of FIGS. 1-5 has an upper stem seal 356 and a lower stem seal 357 sealing the relief valve 200 between the first plunger 361 and the sleeve cap 340. The lower stem seal 357 is retained between the cap 359, and the cap 359 has a larger outer diameter than that of the actuation module passage 312. At least one vent opening 314 in communication with the actuation module passage 312 above the sleeve cap 340 places the actuation module passage 312 in fluid communication with an actuation module exhaust chamber 342 defined between the bonnet 320 and the sleeve cap 340. The actuation module exhaust chamber 342 extends about the exterior of the sleeve 170, between the sleeve 170 and the valve body 110, and is thereby in communication with the outlet 90. The lower stem seal 357 seals the actuation module passage 312 when the first plunger 361 is in the retracted position, as shown in FIG. 5. When the first plunger 361 is extended, the lower stem seal 357 is unseated and moves to permit passage of water from the relief chamber 201 into the actuation module passage 312, as shown in FIGS. 6-7 and 10-11. When water enters the actuation module passage 312, a flow portion 343 of the first plunger 361 allows for passage of water between the first plunger 361 and the actuation module passage 312 to and through the vent opening(s) 314. The flow portion 343 does not fill the entire volume of the passage 312, for example by having a cross-shaped (+) cross section or the like, or because the outer diameter of the flow portion 343 is smaller than the inner diameter of the actuation module passage 312. As shown in FIGS. 2, 4, and 13, the head 370 of the first plunger 361 has two threaded holes 373 on opposite sides of the central passage 363 that receive adjustable activation members 374 in the form of screws or bolts. The second plunger 362 also has a threaded hole 373 opposite the distal end 364 for receiving an additional activation member 374 in the form of a screw or bolt. The functional lengths of the activation members 374 can be adjusted by advancing or retreating the activation members 374 within their respective threaded holes 373. A securing member 375, such as a nut, can also be used to secure the position of the activation member 374 within the threaded hole 373.

The upper stem seal 356 is positioned to seal between the first plunger 361 and an upper portion of the actuation module passage 312 above the vent opening 314. The first plunger 361 may include a structure that acts as a control stop to limit the movement of the first plunger 361, such movement being limited such that the upper stem seal 356 does not enter the vent opening 314. For example, in the embodiment of FIGS. 1-5, the first plunger 361 has an enlarged head 370 that abuts the end of the internal wall 345 to function as a movement stop for the first plunger 361. As mentioned herein, a first biasing member 367, such as a spring, engages the sleeve cap 340 and the head 370 of the first plunger 361 to bias the first plunger 361 toward the retracted position.

The second plunger 362 has an inner plunger seal 371 engaged between the shaft 366 of the second plunger 362 and the inner surface of the central passage 363 of the first plunger 361, to prevent water from flowing out of the flushometer 100 through the central passage 363. The second plunger 362 also includes a flange 372 near the distal end 364 that is wider than the central passage 363 and forms a stop to prevent the second plunger 362 from traveling further into the central passage 363 under the influence of the second biasing member 368, thereby defining the retracted position. The head piece 365 and the end piece of the second plunger 362 are connected together by a threaded connection in the embodiment of FIGS. 1-5, but may be connected in other configurations in other embodiments.

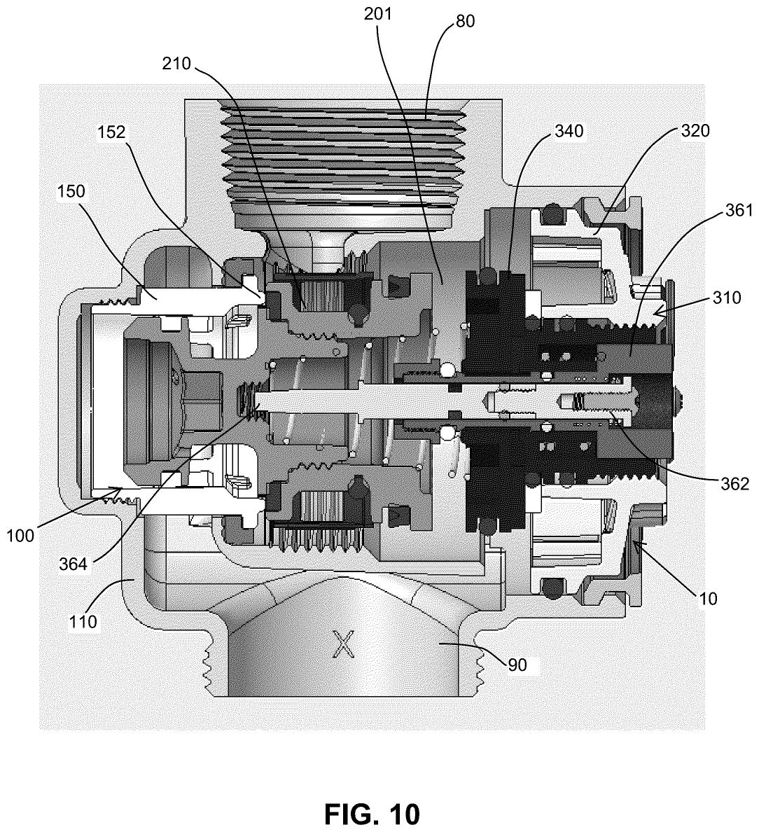

The actuation module 310 permits the flushometer to be operated in two different flush cycles, including a small volume or “half flush” cycle and a large volume or “full flush” cycle. FIGS. 6-9 illustrate the operation of the full flush cycle, and FIGS. 10-12 illustrate operation of the half flush cycle, of the embodiment of FIGS. 1-5. It is understood that the equilibrium state is shown in FIG. 5, and that both the half flush and full flush cycles begin and end in the condition shown in FIG. 5.

The full flush cycle is activated by exerting an axial force on one or both of the activation members 374 connected to the first plunger 361, which moves the first plunger 361 axially within the actuation module passage 312 from the retracted position (FIG. 5) to the extended position (FIG. 6). During this movement, the position of the second plunger 362 does not change. This axial movement opens the relief valve 200 by unseating the lower stem seal 357 from the sleeve cap 340 as shown in FIG. 6, which exposes the relief chamber 201 to the exhaust chamber 342 to the low pressure (typically atmospheric) on the outlet side of the flushometer 100. This permits the relief chamber 201 to be vented and evacuated by flow of water through the actuation module passage 312, the vent opening(s) 314, and the actuation module exhaust chamber 342, and then out through the outlet 90. This creates an imbalance of pressures on the piston assembly 210, as the inlet-side pressure within the valve chamber 112 is higher (typically 10-100 PSI). This results in the piston assembly 210 moving a first distance D1 away from the main valve seat 152 as the valve chamber 112 enlarges and the relief chamber 201 shrinks, as shown in FIG. 7. As the main valve seal portion 250 of the piston 220 is unseated from the main valve seat 152, water is able to flow over the main valve seat 152 from the inlet 80 and out through the one or more main valve outlets 160 to the outlet 90.

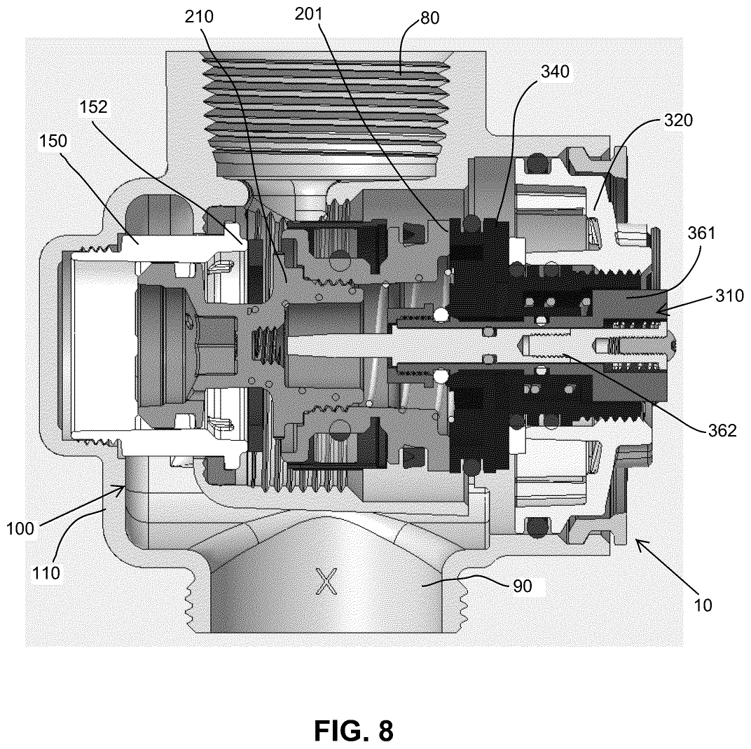

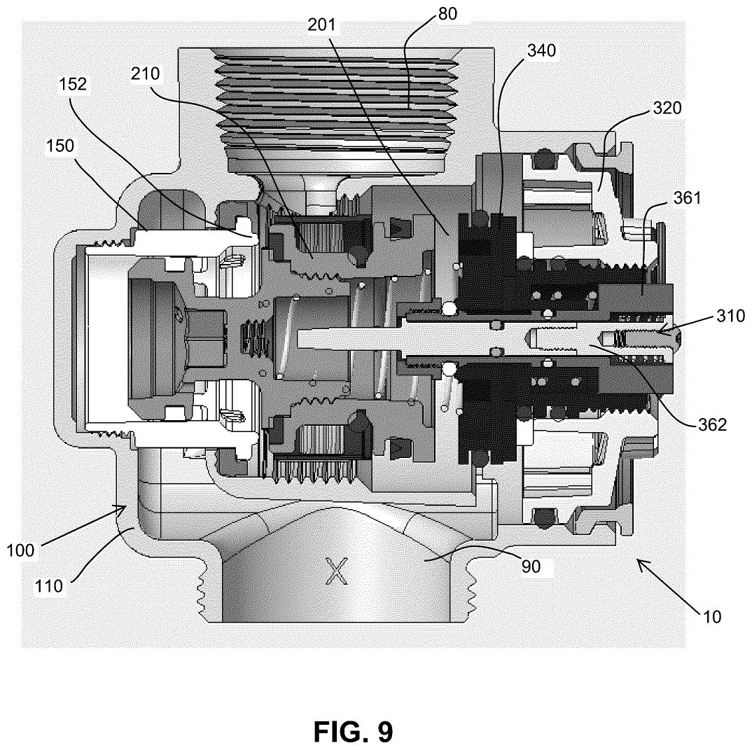

The movement of the piston 220 also moves the attached flow control 270. For embodiments where the flow control includes a plug portion 290, the plug portion 290 restricts the flow of water (such as to about 5 gpm) until the plug portion 290 has withdrawn from the main valve seat assembly 150 and water is free to pass through the main valve seat assembly 150 without flowing over the plug portion 290. Thus, the initial phase of the flush cycle involves an immediate hydraulic venting but has a relatively low flow of water comparative to the maximum possible flow rate from the inlet 80. The by-pass openings in the relief portion 240 of the piston 220 permit water to slowly flow through to the relief chamber 201. After the first plunger 361 is returned to the retracted position and the relief valve 200 is closed as shown in FIG. 8, the water from the valve chamber 112 flowing through the by-pass openings begins to refill the relief chamber 201 and the pressure begins to equilibrate. The piston 220 begins to travel back towards the main valve seat 152 to reseat, as shown in FIG. 9. As the plug portion 290 re-enters the main valve seat assembly 150, the flow rate is affected. Further, as the main valve seal portion 250 approaches the main valve seat assembly 150, the snubber portion 275 of the flow control 270 is disposed within the main valve inlet 157, and the hydraulic interaction with the snubber portion 275 slows the closing of the flushometer 100. Finally, the main valve seal portion 250 re-engages with the main valve seat 152 to close the main valve seat assembly 150 and return the flushometer 100 to the equilibrium state, as shown in FIG. 5.

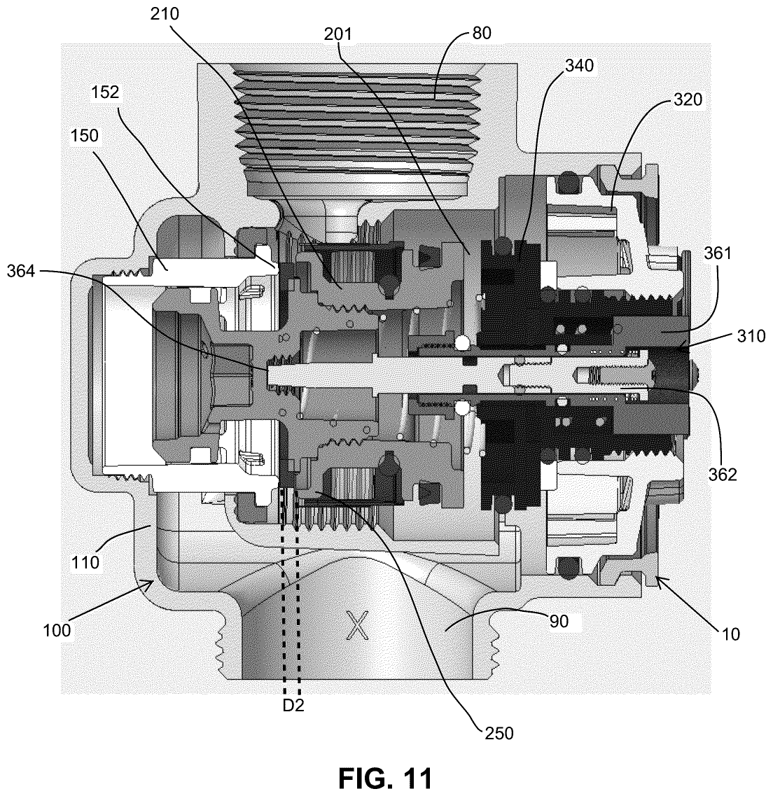

The half flush cycle is activated by exerting an axial force on the activation member 374 connected to the second plunger 362, which moves the second plunger 362 axially within the central passage 363 of the first plunger 361, from the retracted position (FIG. 5) to the extended position (FIG. 10). This axial movement of the second plunger 362 exerts an axial force on the first plunger 361 via the biasing member 368 and also moves the first plunger 361 axially from the from the retracted position (see FIG. 10). In the embodiment of FIGS. 1-5, the first plunger 361 does not move as far axially in the half flush cycle (FIG. 10) as in the full flush cycle (FIG. 6). Thus, the first plunger 361 may have a first extended position in the full flush cycle and a second extended position in the half flush cycle. In another embodiment, the first plunger 361 may move the same axial distance in both the half flush and full flush cycles. The movement of the first plunger to the extended position opens the relief valve 200 by unseating the lower stem seal 357 from the sleeve cap 340 as shown in FIG. 10, which vents and evacuates the relief chamber 201 as described above. This also results in the piston assembly 210 moving a second distance D1 away from the main valve seat 152 to unseat the main valve seal portion 250 of the piston 220 from the main valve seat 152, allowing water to flow over the main valve seat 152 from the inlet 80 and out through the one or more main valve outlets 160 to the outlet 90 as described above. In the half flush cycle, the distal end 364 of the second plunger 362 extends into the hollow body of the piston 220 in the extended position, and engages the piston assembly 210 to obstruct the piston assembly 210 from moving completely through the relief chamber to the sleeve cap 340. Thus, the second distance D2 of movement of the piston assembly 210 is smaller than the first distance D1 in the full flush cycle. This intermediate position of the piston 220 is shown in FIG. 11.

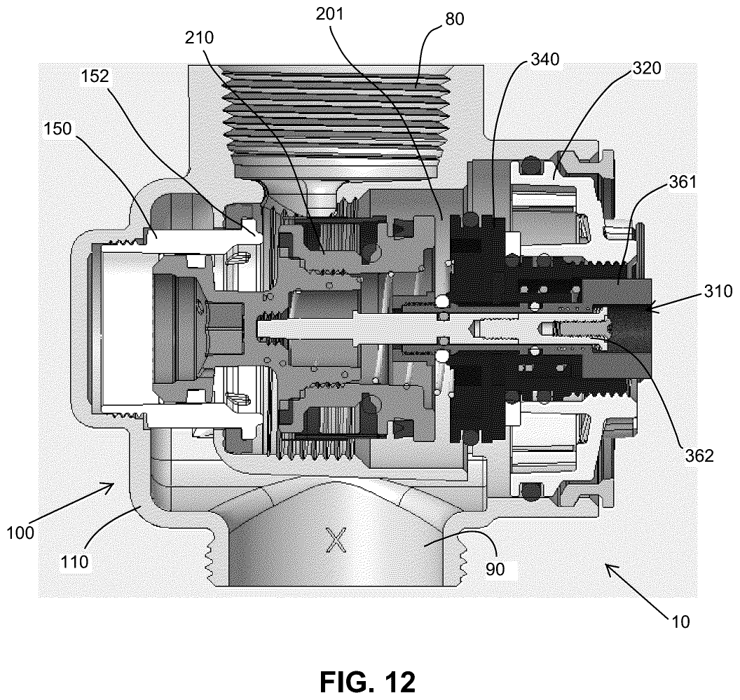

After the first plunger 361 is returned to the retracted position and the relief valve 200 is closed as shown in FIG. 12, the water from the valve chamber 112 flowing through the by-pass openings begins to refill the relief chamber 201 and the pressure begins to equilibrate. The piston assembly 210 begins to travel back towards the main valve seat 152 to reseat, as described above with respect to the full flush cycle. However, the distance the piston 220 needs to travel from the intermediate position (as a result of obstruction by the second plunger 362) to the seated position is smaller than in the fully open position in the full flush cycle. Thus, the main valve seal portion 250 re-engages with the main valve seat 152 to close the main valve seat assembly 150 more quickly in the half flush cycle, resulting in a smaller volume of water flowing through the outlet 90. The main valve seal portion 250 re-engaging with the main valve seat 152 returns the flushometer 100 to the equilibrium state, as shown in FIG. 5.

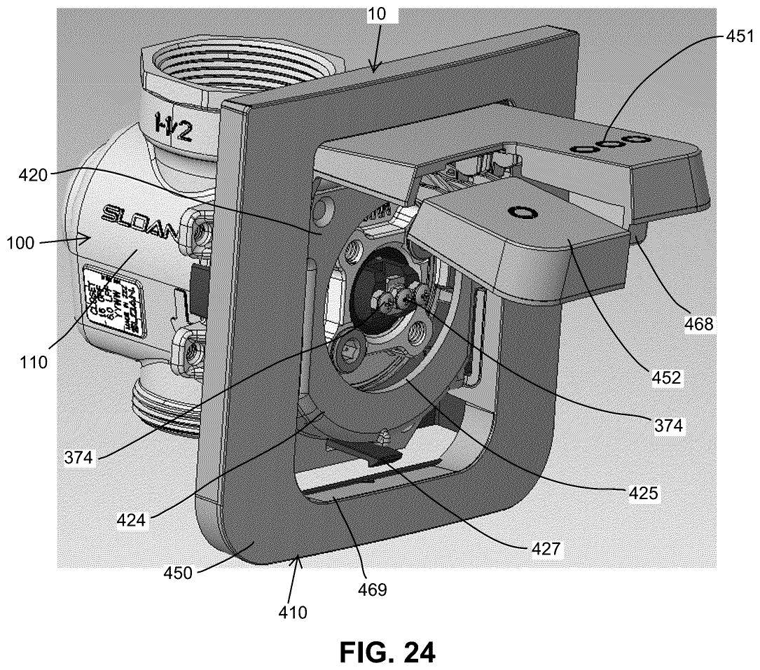

The bonnet 320 may include one or more bosses 321 or protrusions for engaging with a removal tool to adjust the position of the bonnet 320, such as to thread the sleeve 170 to contact the main valve seat 152, as best shown in FIGS. 2 and 24. The bonnet 320 may also include one or more air passages that may act as a vacuum breaker, such as check valves. The air passages provide additional air to the actuation module exhaust chamber. The air passages may be, for example, included in the one or more bosses 321. This functionality of the bosses 321 is shown and described in U.S. Pat. No. 10,948,086, issued Mar. 16, 2021, the entire disclosure of which is incorporated by reference herein.

With reference to FIG. 2, a locking mechanism 390 is further provided in one embodiment. The locking mechanism 390 removably retains the actuation module 310 within the actuation opening 105. In one embodiment, such as shown in FIG. 2, the locking mechanism 390 is a retaining ring, such as a “c” locking retaining ring where the ring has an opening or throat allowing the ring to expand or compress circumference slightly to lock or release, respectively. Additionally, the bonnet 320 includes a periphery having a diameter sized to allow the locking mechanism 390 to be disposed about it. The actuation module 310, piston assembly 210, and sleeve 170 may be threaded into the valve body 110 a distance to allow the locking mechanism 390 to be inserted or removed. In one embodiment, the locking mechanism 390 is only removable (or insertable) when the sleeve 170 is engaged with the main valve seat 152, thus operating as a control stop and closing the valve. This ensures the actuation module 310 and piston assembly 210 can only be removed when the sleeve 170 is engaged as a control stop, i.e., the water from the inlet is shut off. When sleeve 170 is not positioned against the main valve seat 152, the actuation module 310, and the sleeve 170 are separated from the main valve seat 152, and the bonnet 320 engages the locking mechanism 390 while the locking mechanism 390 also engages the valve body 110. The locking mechanism 390 retains the actuation module 310 from being removed while the locking mechanism 390 is in place relative to the valve body 110. It should be appreciated that the locking mechanism 390 may utilize a groove on the valve body that engages a protrusion of the locking mechanism or vice versa.

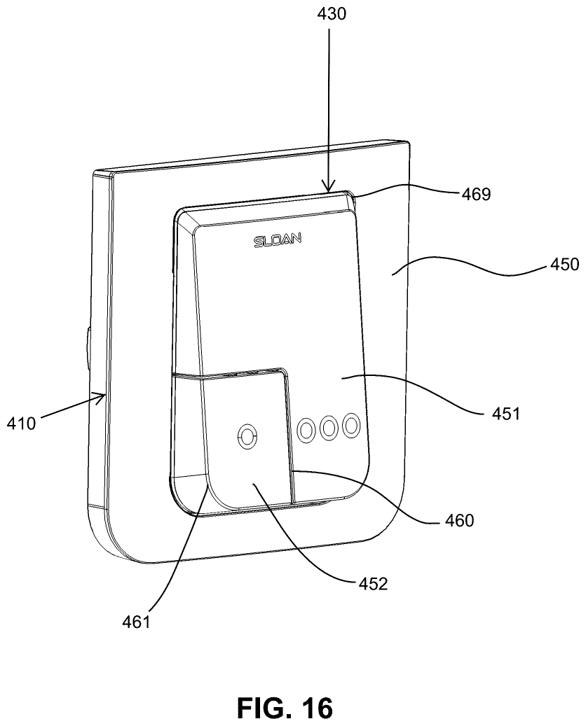

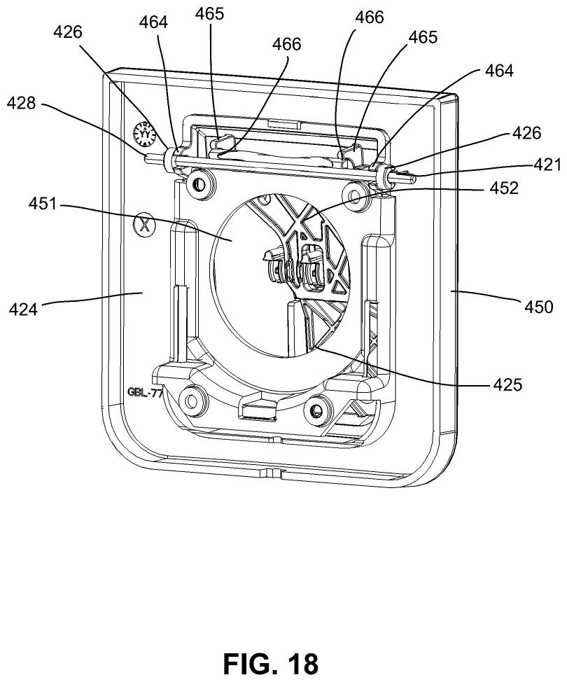

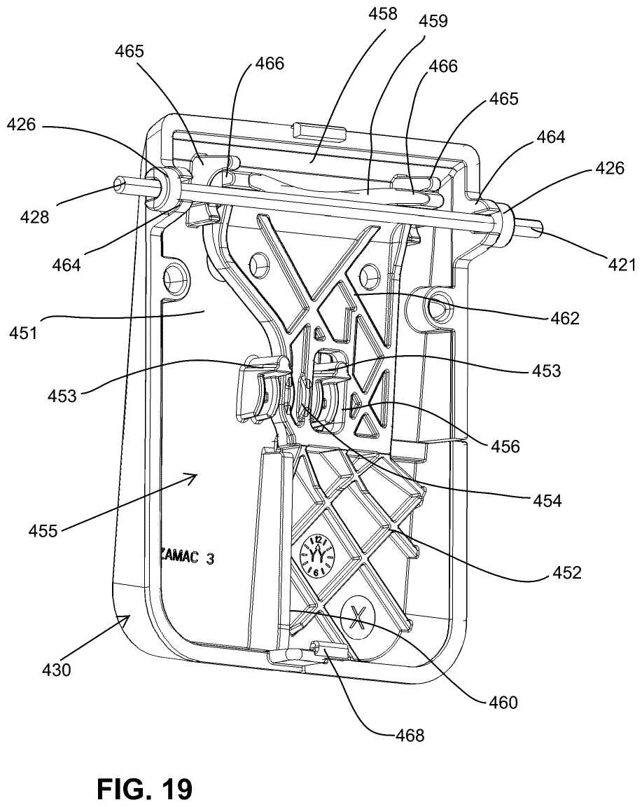

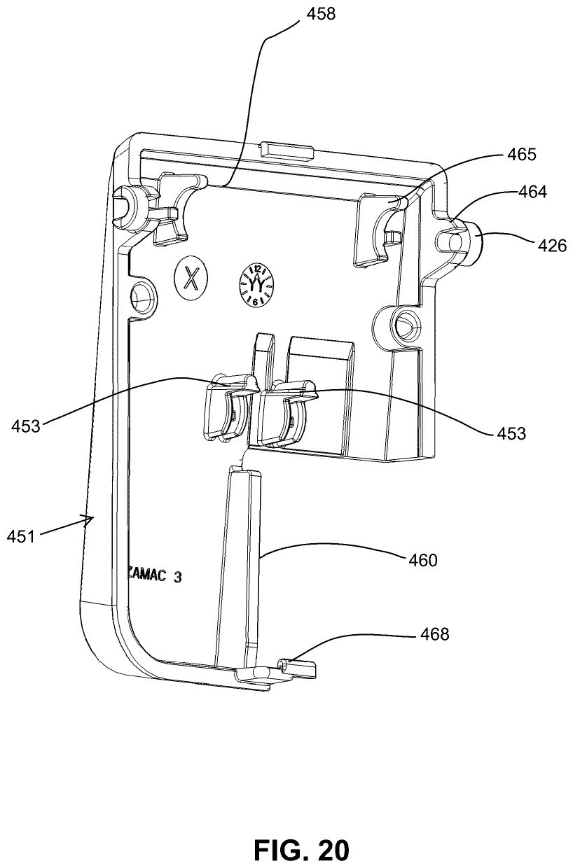

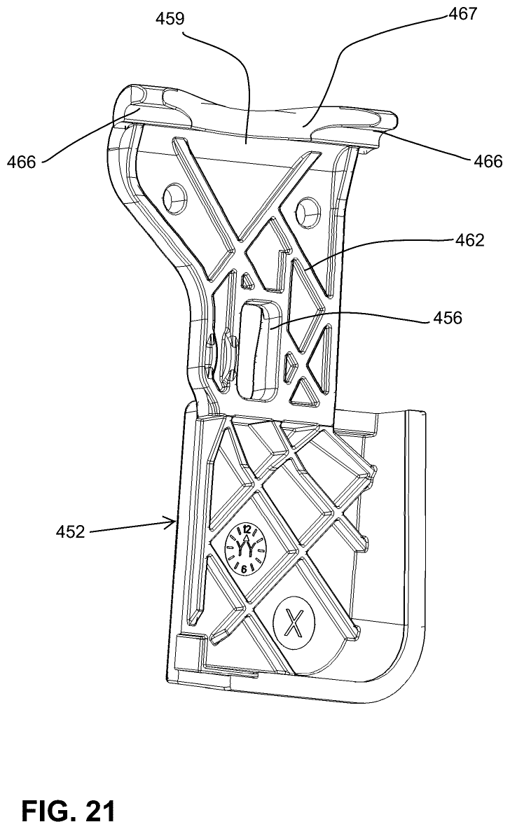

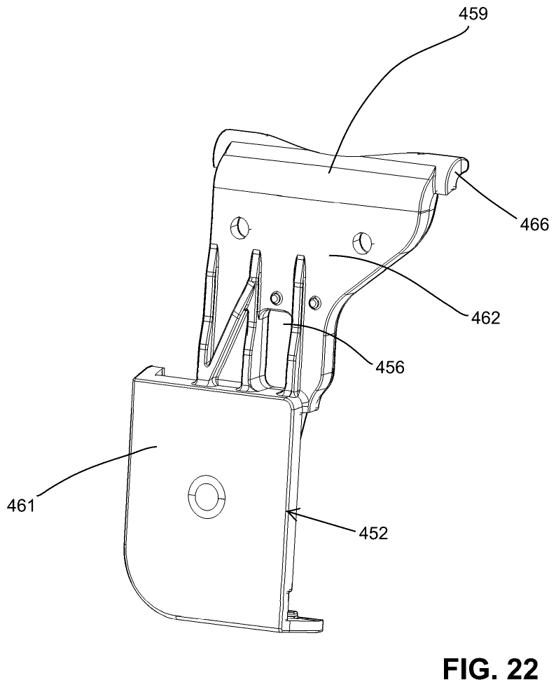

FIGS. 16-24 illustrate the actuation mechanism 350 as a manual actuation mechanism that is actuated by a face plate assembly 410. In another embodiment, the flushometer 100 may be configured for use with an automatic actuation mechanism (not shown).

The face plate assembly 410 may include a face plate 450, a mounting ring 420, and an actuator assembly 430 that includes a first actuator 451 and a second actuator 452. The mounting ring 420 is removably securable to the valve body 110, and the face plate 450 is secured to the mounting ring 420. The first and second actuators 451, 452 are pivotably or otherwise moveably mounted on the mounting ring 420. The first actuator 451 is configured to operably engage the first plunger 361 of the plunger assembly 360, and the second actuator 452 configured to operably engage the second plunger 362 of the plunger assembly 360. The mounting ring 420 includes an inner piece 422 that has walls 423 extending around a portion of the flushometer 100 and an outer piece 424 fastened to the inner piece 422 and serving as a mount for the actuators 451, 452. The inner and outer pieces 422, 424 are fastened together and fastened to the valve body 110 by fasteners such as screws or bolts extending through the inner and outer pieces 422, 424. The face plate 450 is positioned around the mounting ring 420 and includes an actuator opening 469 that receives the first and second actuators 451, 452 and permits access to the mounting ring 420 and the flushometer 100.

Each of the first and second actuators 451, 452 includes an actuation member 453, 454 that is configured to engage the actuation module 310 through an access opening 425 on the mounting ring 420. The first actuator 451 has two actuation members 453 extending inwardly from the inner surface 455 of the actuator assembly, which are configured to engage the activation members 374 connected to the first plunger 361. The second actuator 452 has one actuation member 454 extending inwardly from the inner surface 455 of the actuator assembly 430, which is configured to engage the activation member 374 connected to the second plunger 362. The actuation member 454 of the second actuator 452 is positioned between the two actuation members 453 of the first actuator 451.

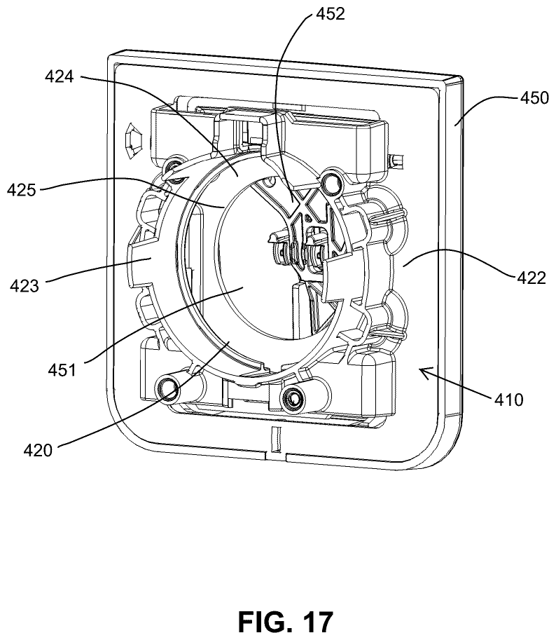

The actuation members 453 of the first actuator 451 in the embodiment of FIGS. 16-24 are best illustrated in FIGS. 17-20. In this embodiment, the actuation members 453 are elongated prongs that extend inward from the inner surface 455 of the actuator assembly 430. The actuation members 453 have lengths greater than the thickness of the second actuator 452, such that the actuation members 453 extend past or through the entire thickness of the second actuator 452. The actuation members 453 in one embodiment may be configured to engage one or both of the activation members 374 of the first plunger 361 to resist rotation of the first plunger 361 within the actuation module passage 312. For example, the ends of the actuation members 453 may be sized and shaped to engage the cross-shaped indentations in the ends of the activation members 374 in the form of screws. One of the actuation members 453 extends through a slot 456 in the second actuator 452 to access the corresponding activation member 374 connected to the first plunger 361.

The actuation member 454 of the second actuator 452 in the embodiment of FIGS. 16-24 is best illustrated in FIGS. 17-19 and 21. In this embodiment, the actuation member 454 is in the form of a ridge on the inner surface 455 of the actuator assembly 430, which is configured to engage the activation member 374 connected to the second plunger 362. The actuation member 454 of the second actuator 452 does not extend as far toward the valve body 110 as the actuation members 453 of the first actuator 451.

The first and second actuators 451, 452 are connected to the mounting ring 420 at a pivot joint 421, such that the top ends 458, 459 of the first and second actuators 451, 452 are both configured to pivot about the same pivot joint 421. The actuation members 453 of the first actuator 451 are configured to engage at least one of the activation members 374 of the first plunger 361 as the first actuator 451 pivots toward the valve body 110. This pivoting movement of the first actuator 451 is translated substantially into linear movement of the activation members 374 and the first plunger 361 to actuate the full flush cycle as described herein. As shown in FIGS. 16-19, the first actuator 451 overlays a portion of the second actuator 452, such that pivoting of the first actuator 451 toward the valve body 110 may also exert force to pivot the second actuator 452 at the same time. However, due to the shorter extension of the second actuation member 454, the second plunger 362 may not be actuated by this pivoting. The second actuator 452, in contrast, can be pivoted independently of the first actuator 451. The actuation member 454 of the second actuator 452 is configured to engage the activation member 374 of the second plunger 362 as the second actuator 452 pivots toward the valve body 110. This pivoting movement of the second actuator 452 is translated substantially into linear movement of the activation member 374 and the second plunger 362 to actuate the half flush cycle as described herein.

The first and second actuators 451, 452 are nested together as shown in FIGS. 17-19 and 23-24 in the illustrated embodiment. The first actuator 451 has a cut out 460 at one corner, and the second actuator 452 has a contact surface 461 that is exposed within the cut out 460 to permit the contact surface 461 to be pressed by a user. The second actuator 452 also has a leg 462 that extends behind the first actuator 451 to connect to the pivot joint 421. The pivot joint 421 is formed by a rod 428 mounted behind the rear surface of the outer piece 424 of the mounting ring 420 and above an access opening 425 on the outer piece 424. Two retainers 426 are connected to the rod 428 on opposite sides of the access opening 425 to retain the rod 428 in connection with the mounting ring 420. In one embodiment, the retainers 426 may be fixed to the mounting ring 420 (e.g., to the outer piece 424); in another embodiment, the retainers 426 may be fixed to the first actuator 451; and in a further embodiment, the retainers 426 may be a type of fastener that is separate. The first actuator 451 is overlaid on the second actuator 452, and the actuators 451, 452 are then connected to the pivot joint 421. The first actuator 451 has two outer receivers 464 that each receive a portion of the rod 428, and two holders 465 located toward the center of the first actuator 451 from the outer receivers 464. The holders 465 have curvilinear surfaces and receive two inner receivers 466 of the second actuator 452. The two inner receivers 466 have curvilinear outer surfaces, such that the second actuator 452 can pivot on the rod 428 and can pivot within the holders 465 as well. In the embodiment of FIGS. 16-24, the inner receivers 466 are formed as curved end parts of a single extension 467 at the top end of the second actuator 452.

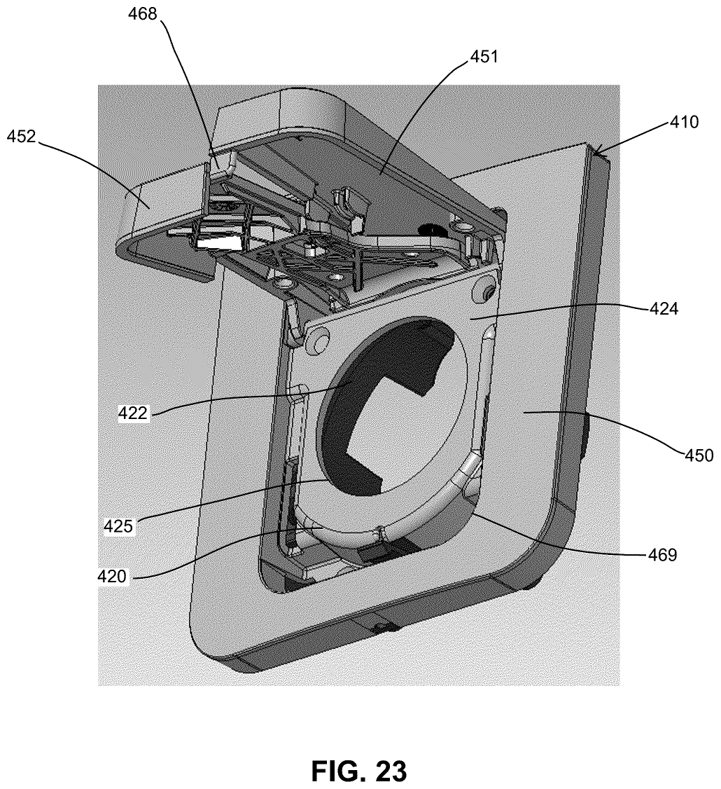

The first and second actuators 451, 452 are also configured for pivoting outward away from the valve body 110 to an access position to permit access to the flushometer through the actuator opening 469 of the face plate 450 and the access opening 425 of the mounting ring 420. The mounting ring 420 has a tab 427 or other retainer extending outward away from the valve body 110 (see FIGS. 3 and 23-24) at the bottom of the mounting ring 420. The actuator assembly 430 includes an arm 468 that is engaged by the tab 427 to releasably retain the first and second actuators 451, 452 in the rest positions. In the embodiment of FIGS. 16-24, the arm 468 is an extension of the first actuator 451 and is engaged by the tab 427 as shown in FIG. 3, such that the second actuator 452 is held in the rest position by the overlayment of the first actuator 451. Additionally, as shown in FIGS. 23-24, the arm 468 engages the underside of the second actuator 452 such that when the first actuator 451 is lifted to the access position, the arm 468 pulls the second actuator 452 to the access position as well. The actuator assembly 430 (e.g., the first actuator 451) may have a retaining member configured to releasably retain the actuator assembly 430 in the access position as well. For example, the access position retainer (not shown) may be a biasing spring, or one or more interacting tabs that interact with the mounting ring 420 and are positioned at an opposite end of the actuator assembly 430 from the arm 468.

Various embodiments of flushometers and flushometer systems have been described herein, which include various components and features. In other embodiments, the flushometers and flushometer systems may be provided with any combination of such components and features. It is also understood that in other embodiments, the various devices, components, and features of the flushometers and flushometer systems described herein may be constructed with similar structural and functional elements having different configurations, including different ornamental appearances.

The flushometers and flushometer systems disclosed herein provide benefits and advantages over existing devices and systems. For example, the flushometers and flushometer systems disclosed herein provide dual-volume flush performance in a compact flushometer installed in or behind a wall. Additionally, the face plate assembly disclosed herein provides an effective way of actuating the flushometer for dual-flush performance, as well as convenient and effective access to the flushometer for service and installation. Still other benefits are recognizable to those skilled in the art.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. The terms “top,” “bottom,” “front,” “back,” “side,” “rear,” “proximal,” “distal,” and the like, as used herein, are intended for illustrative purposes only and do not limit the embodiments in any way. Nothing in this specification should be construed as requiring a specific three dimensional orientation of structures in order to fall within the scope of this invention, unless explicitly specified by the claims. When used in description of a method or process, the term “providing” (or variations thereof) as used herein means generally making an article available for further actions, and does not imply that the entity “providing” the article manufactured, assembled, or otherwise produced the article. The term “approximately” as used herein implies a variation of up to 10% of the nominal value modified by such term, or up to 10% of a midpoint value of a range modified by such term. The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. Additionally, the term “plurality,” as used herein, indicates any number greater than one, either disjunctively or conjunctively, as necessary, up to an infinite number. Accordingly, while the specific embodiments have been illustrated and described, numerous modifications come to mind without significantly departing from the spirit of the invention and the scope of protection is only limited by the scope of the accompanying claims.

What is claimed is:

1. A flushometer system comprising:
a valve body having an inlet, an outlet, and an actuation opening;
a main valve seat assembly disposed in the valve body between the inlet and the outlet;
a piston assembly slidably disposed within the valve body and configured for sealing the main valve seat assembly and moving to permit liquid to flow through the main valve seat assembly;
an actuation module engaged with the valve body, wherein a relief chamber is defined between the actuation module and the piston assembly, the actuation module configured to vent the relief chamber upon actuation,
wherein the actuation module comprises a first plunger and a second plunger, wherein the first plunger is moveable to vent the relief chamber such that the piston assembly is configured to move a first distance from the main valve seat assembly to permit a first flush volume to flow through the main valve seat assembly,
wherein the second plunger is moveable to vent the relief chamber such that the piston assembly is configured to move a second distance from the main valve seat assembly that is smaller than the first distance to permit a second flush volume to flow through the main valve seat assembly, and wherein the second flush volume is smaller than the first flush volume.

2. The flushometer system of claim 1, further comprising:
a sleeve adjustably engageable with the valve body, the sleeve movable relative to the valve body to be engaged and disengaged from the main valve seat assembly, wherein the piston assembly is slidably disposed within the sleeve, and the relief chamber is defined within the sleeve.

3. The flushometer system of claim 2, wherein the actuation module is removably engageable with the sleeve.

4. The flushometer system of claim 1, wherein the inlet and outlet have a vertical axis running therethrough and the actuation opening is perpendicular to the vertical axis and defines a horizontal axis.

5. The flushometer system of claim 1, wherein the first plunger has a central passage extending therethrough, and the second plunger is slidably disposed within the central passage of the first plunger.

6. The flushometer system of claim 5, wherein the first plunger is moveable independently of the second plunger.

7. The flushometer system of claim 5, wherein movement of the second plunger is configured to cause movement of the first plunger to vent the relief chamber.

8. The flushometer system of claim 1, wherein the second plunger has a distal end extending into the relief chamber, and wherein the distal end of the second plunger is configured to engage the piston assembly to obstruct movement of the piston assembly when the second plunger is moved to vent the relief chamber.

9. The flushometer system of claim 1, further comprising a first biasing member configured to bias the first plunger away from the piston assembly and a second biasing member configured to bias the second plunger away from the piston assembly.

10. The flushometer system of claim 1, wherein the piston assembly further comprises a piston configured to move away from the main valve seat assembly when the relief chamber is vented and a flow control extending from the piston assembly into the main valve seat assembly.

11. A face plate assembly configured for manual actuation of a flushometer mounted within or behind a wall surface, the manual flushometer having a first plunger and a second plunger, the face plate assembly comprising:
a face plate configured for mounting on the wall surface;
a mounting ring mounted behind the face plate and configured to be engaged with the flushometer; and
an actuator assembly comprising a first actuator and a second actuator pivotably mounted on the mounting ring and positioned within an opening in the face plate, wherein the first actuator has a first actuation member configured to operably engage the first plunger move the first plunger when the first actuator is pivoted toward the flushometer, and wherein the second actuator has a second actuation member configured to operably engage the second plunger move the second plunger when the second actuator is pivoted toward the flushometer.

12. The face plate assembly of claim 11, wherein the first actuator overlies a portion of the second actuator.

13. The face plate assembly of claim 11, wherein the first actuator and the second actuator are pivotably coupled to a rod defining a single pivot axis for the first actuator and the second actuator.

14. The face plate assembly of claim 11, wherein the first actuator and the second actuator are further pivotable away from the flushometer to an access position configured to permit access to the flushometer, and wherein the first actuator has an arm engaging the second actuator, such that movement of the first actuator to the access position is configured to move the second actuator to the access position.

15. The face plate assembly of claim 11, wherein the first actuator has an additional first actuation member, wherein the second actuator has a slot, and the additional first actuation member is received through the slot and configured to operably engage the first plunger through the slot.
